(19) United States
(12) Patent Application Publication
(10) Pub. No.: US 2016/0290850 A1
(43) Pub. Date: Oct. 6, 2016

(54) Radar-Operated Level Gauge

(71) Applicant: VEGA GRIESHABER KG, Wolfach (DE)

(72) Inventors: Günter Kech, Wolfach-Kirnbach (DE); Fritz Lenk, Schiltach (DE); Klaus Kienzle, Zell a. H. (DE); Jürgen Motzer, Gengenbach (DE)

(21) Appl. No.: 15/032,565

(22) PCT Filed: May 28, 2014
(86) PCT No.: PCT/EP2014/061187

§ 371 Date: Apr. 27, 2016

(30) Foreign Application Priority Data
Dec. 19, 2013 (DE) 10 2013 226 778.9

(51) Int. Cl. G01F 23/284; H01P 1/04; H01P 3/127

(52) U.S. Cl. CPC G01F 23/284; H01P 3/127; H01P 1/042

(57) ABSTRACT

A radar-operated level gauge comprising a signal generator for generating and emitting electromagnetic waves of a wavelength and comprising a straight measuring tube, which consists of at least two parts comprising a first measuring tube section and a second measuring tube section, both of which are joined together at a joining point, wherein the joining ends of the first measuring tube section and the second measuring tube section correspond to each other and are cut off at an angle, and that a circumferential end edge of each of the joining ends extends in the longitudinal direction of the measuring tube.

### CROSS REFERENCE TO RELATED APPLICATIONS

This patent application claims priority to International Patent Application PCT/EP2014/061187, filed on May 28, 2014, and thereby to German Patent Application 10 2013 226 778.9, filed on Dec. 19, 2013.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

1. Field of the Invention

The invention relates to a radar-operated level gauge.

2. Background of the Invention

The prior art discloses level gauges comprising a signal generator for generating and emitting electromagnetic waves of a specific wavelength. In this case the level is measured by means of a so-called measuring tube, which can be designed, for example, as a standpipe or a bypass tube in a tank and which acts on the electromagnetic waves as a waveguide for guiding the electromagnetic waves. Such level gauges are generally used to measure the level of liquids, where in this case the measuring tube is formed as a cylindrical tube, into which the filling material, i.e., in particular, the liquid, enters. The emitted electromagnetic waves, which are guided in the measuring tube, are at least partially reflected at an interface of the filling medium, so that the level of the medium inside the measuring tube can be determined by measuring the distance of travel.

A level gauge of this type lends itself especially well to liquids, for example, solvents or liquid gases as well as foam-generating liquids and to filling materials of low dielectric conductivity ε.

FIG. 6 shows two examples of the application of such radar-operated level gauges 1 for measuring the level in a tank 100. A measuring tube 5 for guiding the electromagnetic waves, which are generated and emitted by a signal generator 3, can be designed as either a so-called standpipe 58, as shown in the left portion of FIG. 6, or as a bypass 57, which is connected to the tank 100 on the side. An additional measuring probe may be arranged in both the standpipe 58 and the bypass 57.

In this context the bypass 57 is connected by means of fluid passages 59 to a main chamber of the tank 100, so that the level inside the bypass 57 is representative of the level in the tank 100. In the present exemplary embodiment the standpipe 58 is designed as a tube that is open at the bottom and, if desired, is provided with additional openings, so that the level in the standpipe 58 is also representative of the level of the tank 100.

In the case of the structures, known from the prior art, it is known that the standpipe 58 and the bypass 57, respectively, are made of two or more parts. Such a divided design can be useful, for example, based on the available lengths of pipe and other requirements, for ease of handling, for example, during assembly.

In the prior art such measuring tubes 5 consist of, for example, two parts comprising a first measuring tube section 51 and an adjoining second measuring tube section 52. When fitting the individual measuring tube sections 51, 52 together, the measuring tube sections are cut to length perpendicularly to their longitudinal axis, and then the individual measuring tube sections 51, 52 are welded to each other at a joining point 7.

In the process known from the prior art, it has been found to be problematic that at such joining points 7 there are problems not only with respect to the dimensional stability, in particular, with respect to a correct alignment and joining of the measuring tube sections 51, 52, but also at the joining point 7 there are problems with respect to the additional reflections of the emitted electromagnetic waves, which may distort the measurement results or which make said measurement results unusable due to the intensity of said electromagnetic waves.

The object of the present invention is to provide a radar-operated level gauge comprising a straight measuring tube, which consists of at least two parts, in such a way that the problems, known from the prior art, are avoided.

This object is achieved by means of a radar-operated level gauge exhibiting the features disclosed herein.

### BRIEF SUMMARY OF THE INVENTION

In a preferred embodiment, a radar-operated level gauge (1) comprising a signal generator (3) for generating and emitting electromagnetic waves of a wavelength (λ)—comprising a measuring tube (5), which consists of at least two parts comprising a first measuring tube section (51) and a second measuring tube section (52), both of which are joined together at a joining point (7), characterized in that the joining ends (53, 54) of the first measuring tube section (51) and the second measuring tube section (52) correspond to each other and are cut off at an angle; that a circumferential end edge (55, 56) of each of the joining ends (53, 54) extends in the longitudinal direction (L) of the measuring tube (5).

In another preferred embodiment, the radar-operated level gauge (1), as described herein, characterized in that the first measuring tube section (51) and the second measuring tube section (52) are cut off in such a way that a circumferential end edge (55, 56) of each of the joining ends (53, 54) extends at least over half a wavelength (2) of the emitted electromagnetic waves in the longitudinal direction (L) of the measuring tube (5).

In another preferred embodiment, the radar-operated level gauge (1), as described herein, characterized in that the circumferential end edge (55, 56) extends over at least one, preferably at least two, even more preferably at least three or four wavelengths (λ) of the emitted electromagnetic wave.

In another preferred embodiment, the radar-operated level gauge (1), as described herein, characterized in that the measuring tube sections (51, 52) are cut off at an angle, wherein a plane, which encloses an angle (α) with the longitudinal direction (L) of the measuring tube section, is defined by the circumferential end edge (55, 56).

In another preferred embodiment, the radar-operated level gauge (1), as described herein, characterized in that the angle (α) is no more than 85°, preferably at most 75°, and more preferably no more than 60°.

In another preferred embodiment, the radar-operated level gauge (1), as described herein, characterized in that the first measuring tube section (51) and the second measuring tube section (52) are joined by means of a socket (11).

In another preferred embodiment, the radar-operated level gauge (1), as described herein, characterized in that the socket (11) encloses externally the first measuring tube section (51) and the second measuring tube section (52) at their joining ends (53, 54).

In another preferred embodiment, the radar-operated level gauge (1), as described herein, characterized in that the socket (11) is welded to the measuring tube sections (51, 52).

In another preferred embodiment, the radar-operated level gauge (1), as described herein, characterized in that the socket (11) has longitudinal slots (60); and preferably the measuring tube sections (51, 52) and the socket (11) are welded in these longitudinal slots (60).

In another preferred embodiment, the radar-operated level gauge (1), as described herein, characterized in that the socket (11) is divided in the longitudinal direction and consists of preferably two parts (12).

In another preferred embodiment, the radar-operated level gauge (1), as described herein, characterized in that the two parts (12) are formed as half shells, partial shells, U-shaped profiles or L-shaped profiles.

In another preferred embodiment, the radar-operated level gauge (1), as described herein, characterized in that in addition or as an alternative, the parts (12) are adhesively bonded to the measuring tube sections (51, 52) preferably in the longitudinal direction.

In another preferred embodiment, the radar-operated level gauge (1), as described herein, characterized in that the first measuring tube section (51) and the second measuring tube section (52) are joined by means of at least one flange (13).

In another preferred embodiment, the radar-operated level gauge (1), as described herein, characterized in that a flange (13) is mounted on, preferably welded to, the two measuring tube sections; and the measuring tube sections (51, 52) are clamped together by means of the flange (13).

In another preferred embodiment, the radar-operated level gauge (1), as described herein, characterized in that a flange (13) is mounted on, preferably welded to, a measuring tube section (51, 52); and a retaining ring (15) is mounted on, preferably welded to, the other measuring tube section (51, 52); and the measuring tube sections (51, 52) are clamped together by means of the flange (13) and a compression flange (14), which overlaps the retaining ring (15).

In another preferred embodiment, the radar-operated level gauge (1), as described herein, characterized in that the measuring tube sections (51, 52) are welded circumferentially to each other.

### BRIEF DESCRIPTION OF THE DRAWINGS

FIG. 1 is a line drawing evidencing a side view of a radar-operated level gauge, according to the invention.

FIG. 2 is a line drawing evidencing a joining point, according to the invention.

FIG. 3 is a line drawing evidencing a perspective view of the joining end of a measuring tube section.

FIGS. 4a to e is a line drawing evidencing a number of different joining options.

FIG. 5 is a line drawing evidencing the comparison of the measurement results of an arrangement, according to the prior art, and an arrangement, according to the invention.

FIG. 6 is a line drawing evidencing a measuring arrangement, according to the prior art (already detailed above).

### DETAILED DESCRIPTION OF THE INVENTION

A radar-operated level gauge, according to the invention, comprises a signal generator for generating and emitting electromagnetic waves of a specific wavelength and a measuring tube, which consists of at least two parts comprising a first measuring tube section and a second measuring tube section, both of which are joined to each other at a joining point, and wherein the first measuring tube section has a first end at the joining point, and the second measuring tube section has a second end at the joining point; and wherein the joining ends of the measuring tube sections correspond to each other and are cut off at an angle, and that a circumferential end edge of each of the joining ends has a longitudinal extent in the longitudinal direction of the measuring tube.

The measuring tube sections are designed to be preferably straight and to correspond to each other; and preferably each of these measuring tube sections is cut off in such a way that the circumferential end edge in the longitudinal direction of the measuring tube has a longitudinal extent of at least half a wavelength of the emitted electromagnetic waves.

The term “longitudinal extent” within the scope of the present application is defined as a projection of the circumferential end edge in the longitudinal direction of the measuring tube in the region of the joining point.

The term “cut off at an angle” within the scope of the present application is defined as cut at a significant angle, i.e., in particular, not just at an infinitesimal angle, as is the case due to production tolerances.

Such a design of the joining point of the two measuring tube sections makes it possible to achieve the objective that a reflection of the electromagnetic waves that is generated at the joining point does not, first of all, occur at the same distance from the signal generator of the radar-operated level gauge at all of the points of the joining point; and, as a result, the circumferentially distributed reflections do not produce a single peak with a high amplitude in a received signal, but rather effect a corresponding distribution over the longitudinal extent; and, secondly, due to a reflection, which takes place preferably offset by at least half a wavelength of the emitted electromagnetic waves, a destructive interference causes an additional attenuation of the reflections occurring at the joining point.

In an additional embodiment the measuring tube may be designed so as to be bent. A design of this type is often used, for example, in ballast tanks of ships, where their angular design precludes the use of straight measuring tubes. In this case the longitudinal direction of the measuring tube has to be determined locally at the joining point.

A further propagation of the signal, reflected at the joining point, and, as a result, an attenuation of the maximally occurring amplitude can be achieved by extending the circumferential end edge over at least one, preferably at least two, even more preferably at least three or four wavelengths of the emitted electromagnetic wave. The reflections are distributed by means of such a design over a larger area, so that, if one considers at the total effect, on the one hand, the maximum amplitude will be lower; and, on the other hand, a destructive interference can be achieved for a plurality of positions.

A particularly simple embodiment can be achieved, if the measuring tube sections are cut off at an angle, where in this case a plane, which encloses an angle with the longitudinal direction of the measuring tube or, more specifically, the measuring tube section, is defined by the circumferential end edge. The angle, at which the measuring tube sections are cut off at an angle, amounts preferably to no more than 85°, even more preferably at most 75°, and most preferably no more than 60°, where in this case for adjacent measuring tube sections preferably identical angles with opposite signs are selected. This design makes it possible to achieve the objective of a largely seamless joint between the individual sections of the measuring tube.

It is possible to achieve a simple joint between two measuring tube sections, if the first measuring tube section and the second measuring tube section are joined to each other by means of a socket. Such a socket may enclose externally the first measuring tube section and the second measuring tube section at their joining ends; and, as a result, it is possible to achieve the objective of a straight alignment of the two measuring tube sections relative to each other as well as a stabilization. In one embodiment of the measuring tube as a standpipe, such a plug-in connection with a socket may already be sufficient to join the two measuring tube sections to each other, where in this case it is preferred that the socket be also welded to the measuring tube sections, in order to provide an additional attachment. In principle, such a weld can be produced over the periphery, so that it is possible to introduce additional defects into the measuring tube by means of a weld, for example, at the beginning and at the end of such a socket; and then all of these defects would be once again at a distance from the signal generator.

Therefore, the socket is designed preferably with longitudinal slots, where in this case the measuring tube sections and the socket are welded to each other in these longitudinal slots. In this context it is preferred that the weld be drawn exclusively in the longitudinal direction; and, as an alternative, an embodiment with welds in the transverse direction is also conceivable. Such welds in turn would extend preferably at an angle to a longitudinal direction of the measuring tube.

A particularly simple embodiment may be achieved, if the socket is designed so as to be divided by means of the longitudinal slots and, as a result, consists of preferably two parts. The parts may be designed, for example, as two half shells or thirds of a shell in order to join the measuring tube sections to each other. In one embodiment the two parts of the socket may also be configured as U-shaped profiles or L-shaped profiles.

A weld is produced preferably along the longitudinal edges of the half shells or the U-shaped profiles, where in this case the measuring tube sections are not welded to the half-shells or the U-shaped or L-shaped profiles, in order to avoid reflections preferably in the region of the joining point.

In addition to the longitudinal slots in the region of the joining point, the socket may also have openings, through which a proper alignment of the measuring tube sections relative to each other can be checked.

In an additional embodiment of the present invention the first measuring tube section and the second measuring tube section may be joined to one another by means of at least one flange. A joint that is formed by means of flanges has the advantage that the flanges can be mounted on the measuring tube sections in the unassembled state of the measuring tube and, as a result, can provide easier working conditions. Such a design may have a positive effect, for example, if a flange is mounted on both measuring tube sections, where in this case the flange is preferably welded to the respective measuring tube section, and the measuring tube sections are clamped together by means of the flanges. The application of flanges uses an already tested and reliable joining technology that, however, usually cannot manage without additional sealing systems, in particular, if the measuring tube is used as a bypass.

As an alternative to mounting a flange on each measuring tube section, a flange may be mounted on one measuring tube section, and a retaining ring may be secured, preferably by welding, on the other measuring tube section, where in this case the measuring tube sections are clamped together by means of the flange and a compression flange, which overlaps the retaining ring. A design of this type has the further advantage over a design with two flanges that it is usually possible to rotate the measuring tube section with the retaining ring relative to the measuring tube section with the flange, so that it is very easy to provide an optimal alignment of the measuring tube sections relative to each other.

In all of the aforementioned variants there is the possibility that the emitted electromagnetic waves, which penetrate into the usually unavoidable small gaps between the measuring tube sections, can radiate to the outside, so that here, too, additional reflections are reduced.

In all of the aforementioned embodiments it is possible to provide an adhesive bond, as an alternative to the weld.

In another embodiment the measuring tube sections are circumferentially welded to each other, a process that lends itself particularly well to the use as a bypass, since there is no need for additional sealing systems in this design. A corresponding embodiment with a circumferential weld at the joining point can also be applied in the region of the standpipes, because additional components, such as, for example, the aforementioned flanges and sockets, are not necessary in this arrangement.

A reduction in the resulting reflections at the joining point in terms of their amplitude has also been achieved, in particular, in arrangements, in which tubes of different inside diameters are joined to each other. In this case it is possible to achieve by means of an inventive design of the joining point a significant reduction in the resulting reflections at the joining point in terms of the maximum occurring amplitude. In addition, the same effect could be observed in tubes, which are not laid against each other exactly in the longitudinal direction, but rather deviate in their alignment by a small angle, so that a small gap is produced at least at one point on the periphery of the measuring tube. Furthermore, when there are also variances in the distance, i.e., if the measuring tube sections, which are laid against each other, are not laid exactly against each other; and, as a result, a circumferential gap is produced, it was possible to achieve significantly improved results by means of an embodiment according to the invention.

The procedure, according to the invention, also makes it possible to detect even smaller echoes, for example, from the surfaces of the mediums to be measured, where said mediums to be measured have a low dielectric constant. The overall objective that is achieved is that the signal-to-noise ratio is increased; and as a result, the measuring accuracy is significantly increased by the procedure, according to the invention. The aforementioned measures allowed the false echoes occurring at the joining point to propagate and their amplitude to be reduced by an average of 20 to 25 dB.

### DETAILED DESCRIPTION OF THE FIGURES

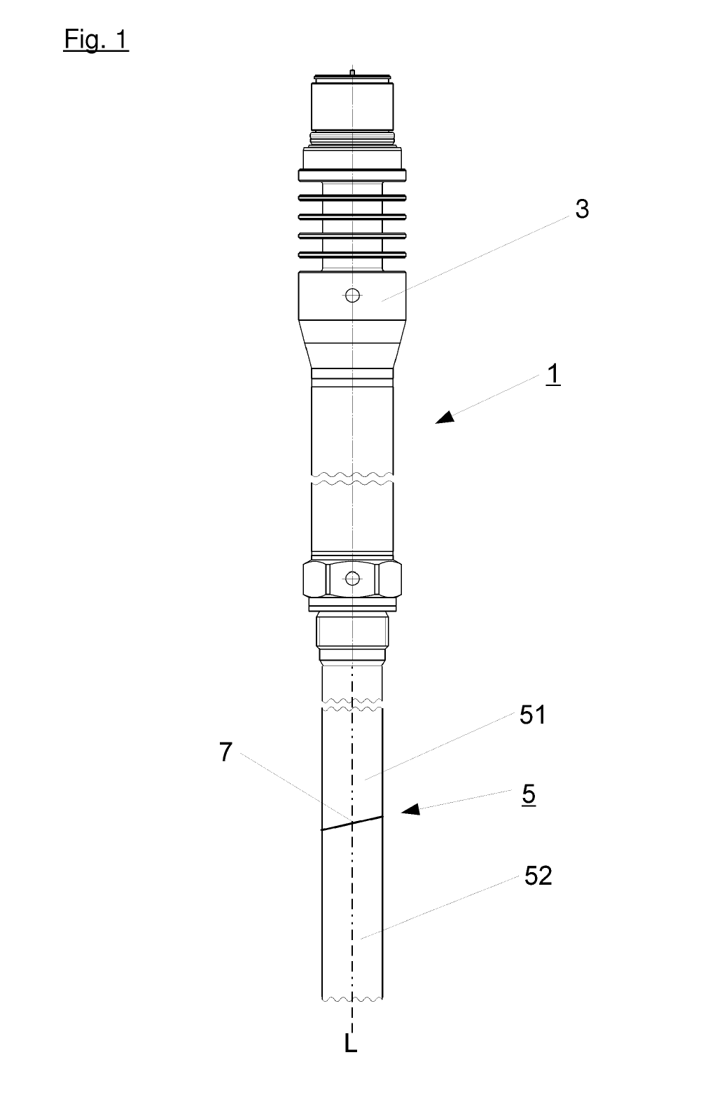

FIG. 1 shows a radar-operated level gauge 1 for determining levels in a tank or rather a container 100. In the present illustration the radar-operated level gauge 1 is shown in a side view, with a signal generator 3 and an electronic evaluation unit being disposed in a rear area behind a wave adapter. However, in the present embodiment neither the signal generator nor the electronic evaluation unit is shown in more detail. The signal generator 3 is designed to be suitable for emitting electromagnetic wave packets with a length of about one nanosecond and at a frequency of about 26 GHz. Additional typical frequencies that are used to measure the filling level range from 5.8 GHz to 6.3 GHz, 10 GHz, 24 GHz to 27 GHz or 75 GHz to 83 GHz.

The electromagnetic waves of a specified wavelength λ can be coupled by way of the wave adapter into a measuring tube 5, which acts on the electromagnetic waves as a waveguide. The electromagnetic waves are guided in the measuring tube 5 in the direction of a filling material, located inside the tank 100, and are reflected at an interface between the filling material and a medium, in particular, air or another gas, that is located above the filling material. Then a measurement of the distance of travel of the electromagnetic wave packets can be used to compute a level inside the tank 100. In addition to reflections at the interface, i.e., at the surface of the filling material, reflections are also generated at a joining point between a first measuring tube section 51 and a second measuring tube section 52. In the prior art the net effect of the reflections, in particular, at the joining point 7 is that, when, for example, the filling materials have a low

dielectric constant ε, the reflections at the joining point 7 overlap a reflection at the surface of the filling material in the region of the joining point 7, with the result that the reliability of the measurement taken deteriorates significantly.

In the case of the radar-operated level gauge 1, shown in FIG. 1, the measuring tube 5 consists of two parts: a first measuring tube section 51 and a second measuring tube section 52. The first measuring tube section 51 and the second measuring tube section 52 are joined to each other at a joining point 7; in the present exemplary embodiment they are welded together.

In the present exemplary embodiment the joining point 7 is formed in such a way that a first joining end 53 of the first measuring tube section 51 and a second joining end 54 of the second measuring tube section 52 correspond to each other and are cut off at an angle, so that, when considered as a whole, a linear design of the measuring tube 5 is achieved.

In addition, FIG. 1 shows a longitudinal direction L of the measuring tube 5, where in the case of a cylindrically shaped measuring tube said longitudinal direction is determined, for example, by the axis of symmetry.

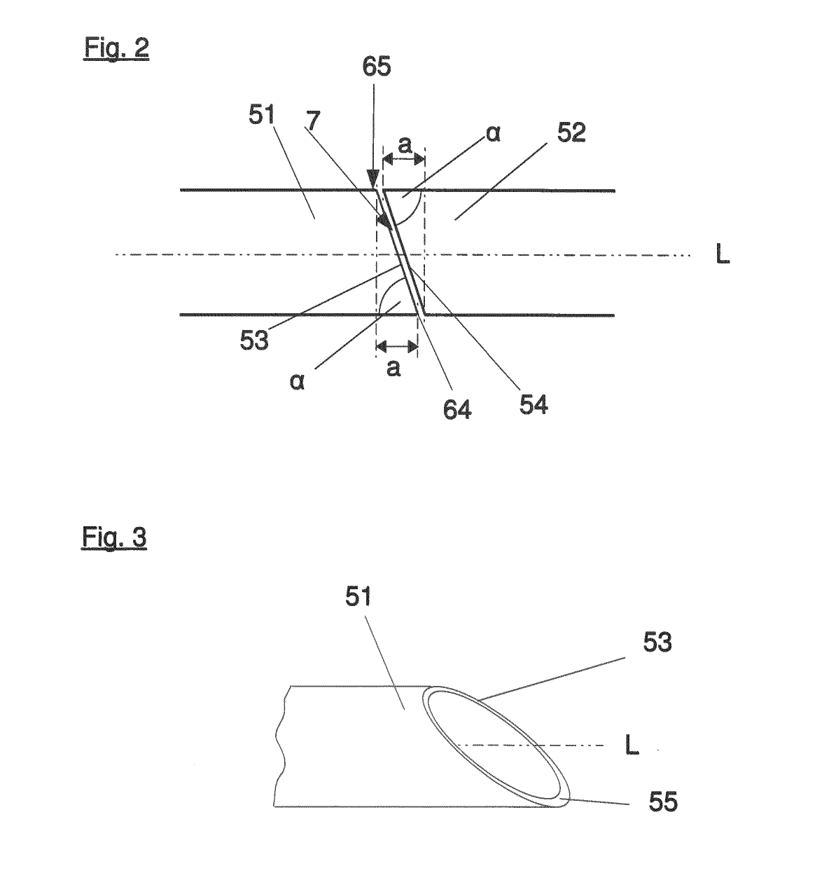

FIG. 2 shows an enlargement of the joining point 7 of the measuring tube 5 from FIG. 1. In the illustration in FIG. 2 the measuring tube 5 from FIG. 1 is rotated by 90°, with the two measuring tube sections 51, 52 being not yet completely joined to each other.

In the present exemplary embodiment the two measuring tube sections 51, 52 are cut off at an angle α of 70° relative to the longitudinal direction L of the measuring tube 5. Based on the first measuring tube section 51, a point 64 of a circumferential end edge 55, where said point is located, when viewed in the longitudinal direction L, the furthest towards the front in the direction of the second measuring tube section 52, is offset by a longitudinal extent a, as compared to a rearward-most point 64 of the circumferential end edge 55. As a result, the circumferential end edge 55 extends in its entirety over a longitudinal extent a. In the present exemplary embodiment the measuring tube 5 has a diameter of 85 mm, where in this case an angle α of 70° results in a difference of 29 mm between the forward point 64 and the rearward point 65. At a measurement frequency of 26 GHz, which is equivalent to a wavelength λ of about 11.5 mm, the net result is that a distribution of the individual reflections, which may occur, over approximately three wavelengths λ of the emitted electromagnetic waves is achieved in the present exemplary embodiment. As a result, a projection of the circumferential end edge 55, 56 of the respective joining ends 53, 54 of the measuring tube sections 51, 52 in the longitudinal direction L of the measuring tube 5 exhibits a distance between the forward-most point 64 and the rearward-most point 65 of the respective measuring tube section 51, 52. This feature is particularly easy to see in the case of the tube that is cut off at an angle, but also at the same time more intricate contours of the respective end edge 55, 56 are also conceivable.

The measuring tube sections 51, 52, shown in FIG. 2, may be welded, for example, directly to each other by means of a flanged joint or a socket joint or may be joined together in some other way.

FIG. 3 shows a perspective view of the first measuring tube section 51 from FIG. 2. This illustration shows very clearly a first circumferential end edge 55 of the first joining end 53 of the first measuring tube section 51. The second measuring tube section 52 and its second joining end 54 with the second circumferential end edge 56 are designed to correspond and are not shown in detail in this embodiment.

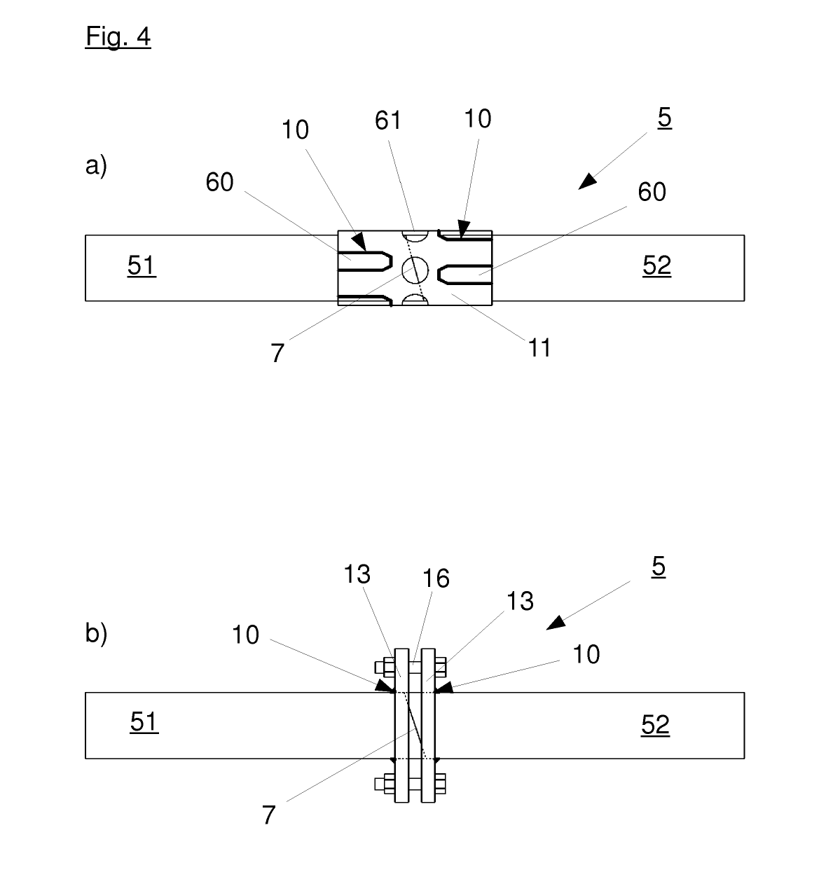

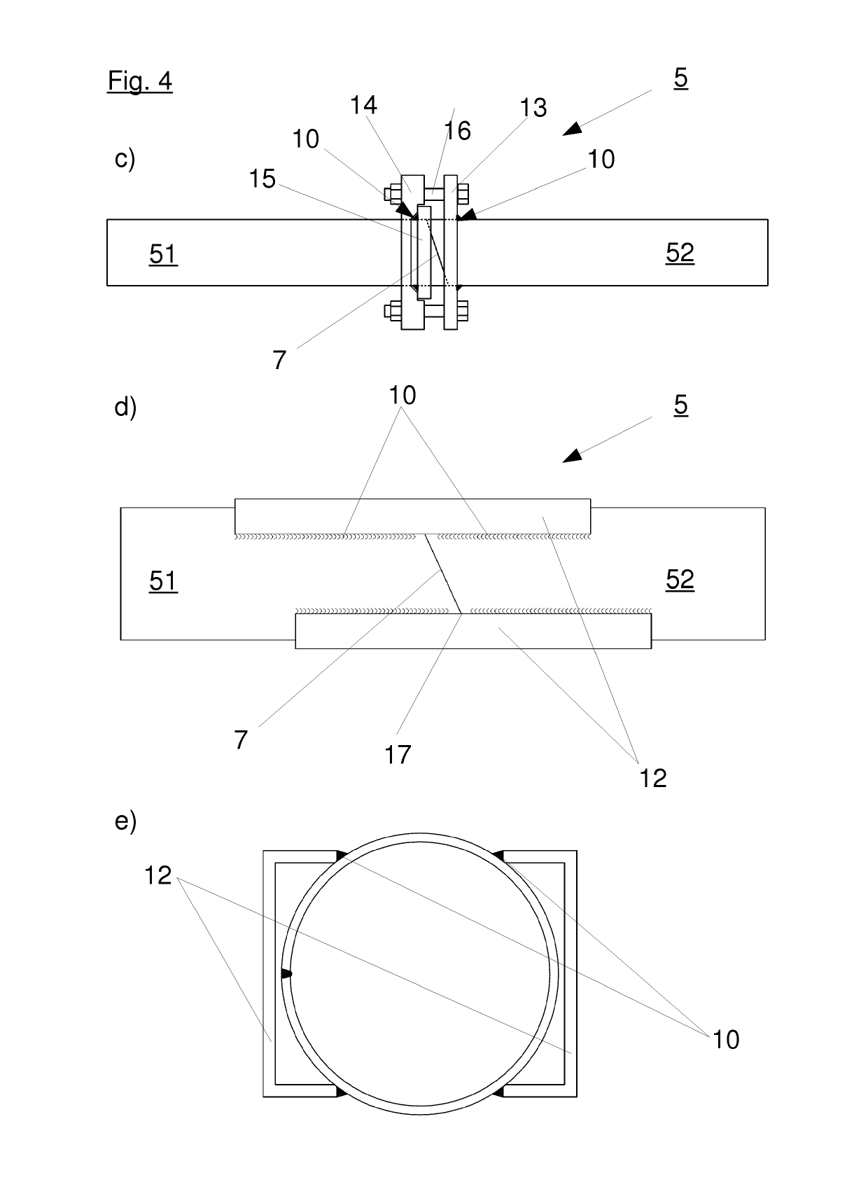

FIGS. 4a to c show a number of options for joining the two measuring tube sections 51, 52 to each other, with these options being possible as an alternative to a weld, as shown in FIGS. 1 and 2.

FIG. 4a shows the first measuring tube section 51 joined to the second measuring tube section 52 by means of a socket 11. In the present exemplary embodiment the socket 11 is designed to be suitable for enveloping the measuring tube sections 51, 52 on the outside and for enclosing said measuring tube sections in a form locking manner. The socket 11 has longitudinal slots 60, which are introduced from the opposite ends of said socket. In the present exemplary embodiment these longitudinal slots are cut into the socket 11 over about one-third of the length, when viewed from the end. In addition to the longitudinal slots 60, the socket 11 has openings 61, which are centrally arranged in the longitudinal direction and are distributed over the periphery of said socket; and in the present embodiment these openings are made as circularly round boreholes. According to FIG. 4a, the measuring tube sections 51, 52 are inserted into the socket 11 in such a way that the joining point 7 is located between the measuring tube sections 51, 52 in the region of the openings 61. As a result, the openings 61 allow the joining point 7 to be examined for gap formation or any variances in the configuration of the ends 53, 54 of the individual measuring tube sections 51, 52.

In addition to the plug-in joint produced by means of the socket 11, the measuring tube sections 51, 52 can also be welded to the socket 11. In this case it is preferred that a weld 10 for joining the measuring tube sections 51, 52 to the socket 11 be guided along the longitudinal edges of the longitudinal slots 60, so that additional defects, which extend in the circumferential direction and which may be caused by the weld 10, can be avoided. In the present embodiment the welds 10 are preferably guided in the longitudinal direction, but they may also extend in sections in the circumferential direction of the measuring tube 5.

FIG. 4b shows the measuring tube sections 51, 52 joined to each other by means of two flanges 13, which are mounted on the ends of the individual measuring tube sections 51, 52 by means of, for example, a weld 10. Then the two flanges 13 in turn are clamped together by means of clamping screws 16, so that a stable joint between the measuring tube sections 51, 52 is achieved. The welds 10, by means of which the flanges 13 are mounted on the measuring tube sections 51, 52, may be either formed circumferentially or implemented by means of individual spot welds. Corresponding spot welds have the advantage that a circumferential weld, which may lead, as already described, to defects in the interior of the measuring tube, is avoided.

FIG. 4c shows a third variant of the joint, at which the measuring tube section 51 is provided with a clamping ring 15; and the second measuring tube section 52 is provided with a flange 13. The clamping ring 15 and the flange 13 may be connected, in a manner analogous to the flanges 13 from FIG. 4b, to their respective measuring tube section 51, 52 either circumferentially to a weld 10 or by means of individual spot welds. In the exemplary embodiment shown in FIG. 4c, the joint between the two measuring tube sections 51, 52 is produced by means of a compression flange 14, which engages behind the clamping ring 15 and is clamped to the flange 13 on the second measuring tube section 52 by means of clamping screws 16. An embodiment according to FIG. 4c has the advantage that a clamping ring 15 makes an alignment in the radial direction of the first measuring tube section 51 to the second measuring tube section 52 readily possible and does not make it difficult due to, for example, a borehole in the flanges 13, as shown in FIG. 4b.

FIG. 4d shows an alternative method for joining the first measuring tube section 51 to the second measuring tube section 52 by means of two U-shaped profiles 12. In the present exemplary embodiment the two U-shaped profiles 12 are designed to be suitable for abutting on the outside of the measuring tube sections 51, 52 and, as a result, for stabilizing them in the longitudinal direction. The measuring tube sections 51, 52 lie in the two U-shaped profiles 12 in such a way that the joining point 7 is arranged approximately centrally in the longitudinal direction. For further stabilization the measuring tube sections 51, 52 are additionally welded to the U-shaped profiles 12. In order to join the measuring tube sections 51, 52 to the U-shaped profiles, it is preferred in this case that a weld 10 be drawn along the longitudinal edges of the U-shaped profiles 12, so that it is possible to avoid additional defects, which extend in the circumferential direction and which are caused by the weld 10. In order to avoid any additional potential defects, the welds 10 also have interruptions 17 in the area of the joining point 7, so that any beads, generated by the welding process, inside the measuring tube sections 51, 52 can be avoided.

As an alternative to a weld, an adhesive bond would also be conceivable.

FIG. 4e shows a cross section of the embodiment from FIG. 4d. In this illustration it can be clearly seen that U-shaped profiles 12 for joining the measuring tube sections 51, 52 were used in the present exemplary embodiment. Such U-shaped profiles make it possible to achieve a simple alignment of the measuring tube sections 51, 52 relative to each other while at the same time optimizing for cost. In particular, it is possible to use, as a rule, standard components, so that it is not necessary to manufacture specially adapted special components.

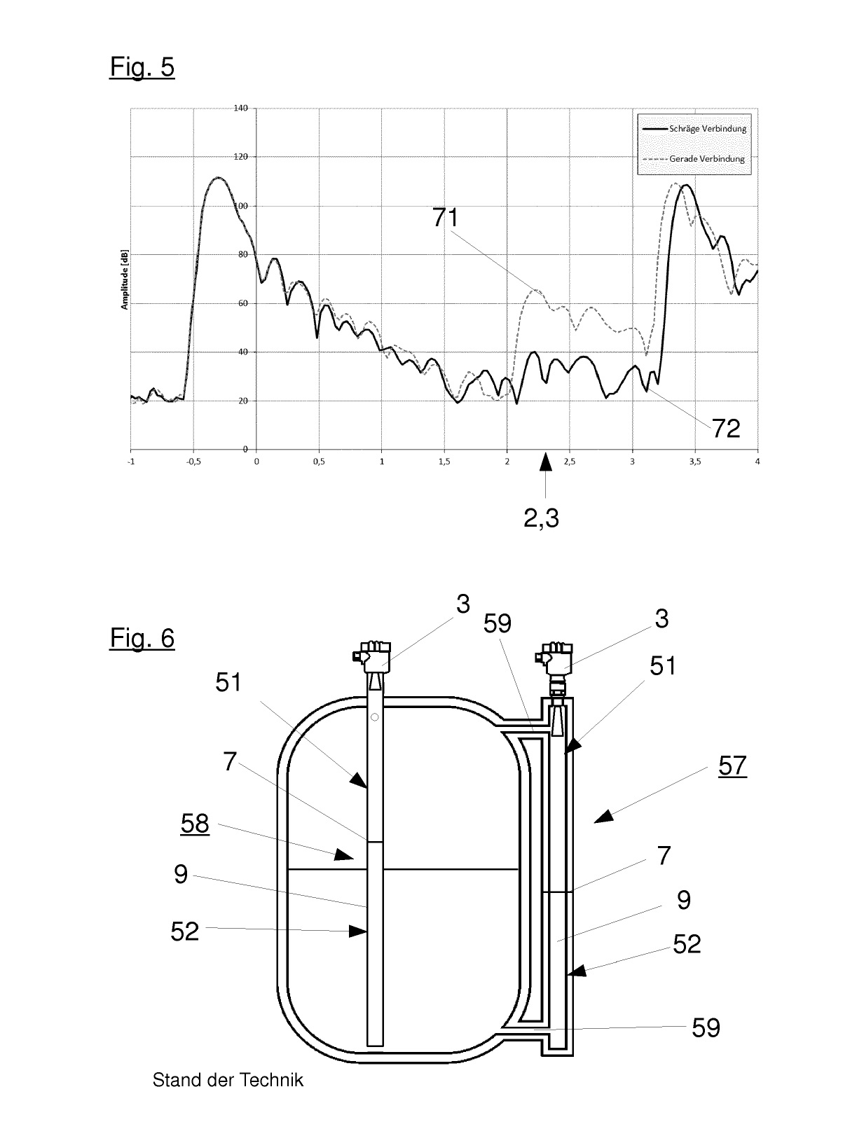

FIG. 5 shows, as an example, wave forms of an arrangement, according to the prior art (curve 71), and an arrangement (curve 52), according to the invention, for purposes of comparison. The two compared curves 71, 72 show in each instance an echo curve, which was recorded by the level gauge 1, where in this case the determined distance values have already been converted into distance in meters and are displayed on the abscissa. The respectively determined signal amplitude at the corresponding distance is displayed on the ordinate.

For the present example of a measurement, a measuring tube 5 having a total length of 3.5 m with a joining point at 2.3 m was used. In this case the curve 71 shows the measurement curve according to the prior art, wherein an echo signal with an amplitude of 65 dB is measured at the joining point at a distance of 2.3 m, and an echo signal having an amplitude of 110 dB is measured at the end of a tube at a distance of 3.5 m. In an inventive arrangement, as explained in conjunction with FIGS. 1 to 4, the maximum amplitude of the echo signal at the joining point 7 at 2.3 m could be reduced by 25 dB to 40 dB, whereas at the tube end at 3.5 m an identical amplitude of 110 dB is measured. The operative effect for the reduction of the echoes at the defects of the joining point 7 is seen in the propagation of the echo signal and a destructive interference of the individual reflections occurring at the various points of the joining point 7. On the whole, this approach significantly increases the signal-to-noise ratio and, as a result, increases the measuring accuracy.

The destructive interference, described above, is already present at a longitudinal extent of the joining point of at least half a wavelength of the emitted electromagnetic waves. However, a significant improvement can be achieved, if the joining point 7 extends over a multiple of the wavelength of the emitted electromagnetic waves.

### LIST OF REFERENCE NUMBERS

1 radar-operated level gauge
3 signal generator
5 measuring tube
7 joining point
9 cable or rod probe
10 weld
11 socket
12 U-shaped profiles/shells
13 flange
14 compression flange
15 retaining ring
16 clamping screw
17 interruption
51 first measuring tube section
52 second measuring tube section
53 first joining end
54 second joining end
55 first end edge
56 second end edge
57 bypass
58 standpipe
59 fluid passages
60 longitudinal slot
61 opening
64 forward point
65 rearward point
71 first measurement curve
72 second measurement curve
100 tank, container
L longitudinal direction
λ wavelength
α angle
a longitudinal extent

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A radar-operated level gauge comprising a signal generator for generating and emitting electromagnetic waves of a wavelength (λ)—comprising a measuring tube, which consists of at least two parts comprising a first measuring tube section and a second measuring tube section, both of which are joined together at a joining point, wherein the joining ends of the first measuring tube section and the second measuring tube section correspond to each other and are cut off at an angle; that a circumferential end edge of each of the joining ends extends in the longitudinal direction of the measuring tube.

2. The radar-operated level gauge, as claimed in claim 1, wherein the first measuring tube section and the second measuring tube section are cut off in such a way that a circumferential end edge of each of the joining ends extends at least over half a wavelength (λ) of the emitted electromagnetic waves in the longitudinal direction (L) of the measuring tube.

3. The radar-operated level gauge, as claimed in claim 1, wherein the circumferential end edge extends over at least one, preferably at least two, even more preferably at least three or four wavelengths (λ) of the emitted electromagnetic wave.

4. The radar-operated level gauge, as claimed in claim 1, characterized in that measuring tube sections are cut off at an angle, wherein a plane, which encloses an angle (α) with the longitudinal direction (L) of the measuring tube section, is defined by the circumferential end edge.

5. The radar-operated level gauge, as claimed in claim 4, wherein the angle (α) is no more than 60°.

6. The radar-operated level gauge, as claimed in claim 1, wherein the first measuring tube section and the second measuring tube section are joined by means of a socket.

7. The radar-operated level gauge, as claimed in claim 6, wherein the socket encloses externally the first measuring tube section and the second measuring tube section at their joining ends.

8. The radar-operated level gauge, as claimed in claim 6, wherein the socket is welded to the measuring tube sections.

9. The radar-operated level gauge, as claimed in claim 8, wherein the socket has longitudinal slots; and preferably the measuring tube sections and the socket are welded in these longitudinal slots.

10. The radar-operated level gauge, as claimed in claim 6, wherein the socket is divided in the longitudinal direction and consists of preferably two parts.

11. The radar-operated level gauge, as claimed in claim 10, wherein the two parts are formed as half shells, partial shells, U-shaped profiles or L-shaped profiles.

12. The radar-operated level gauge, as claimed in claim 8, wherein that in addition or as an alternative, the parts are adhesively bonded to the measuring tube sections preferably in the longitudinal direction.

13. The radar-operated level gauge, as claimed in claim 1, wherein that the first measuring tube section and the second measuring tube section are joined by means of at least one flange.

14. The radar-operated level gauge, as claimed in claim 12, wherein a flange is mounted on, or welded to the two measuring tube sections; and the measuring tube sections are clamped together by means of the flange.

15. The radar-operated level gauge, as claimed in claim 12, wherein a flange is mounted on, preferably welded to, a measuring tube section; and a retaining ring is mounted on, preferably welded to, the other measuring tube section; and the measuring tube sections are clamped together by means of the flange and a compression flange, which overlaps the retaining ring.

16. (canceled)

17. The radar-operated level gauge, as claimed in claim 1, wherein the measuring tube sections are welded circumferentially to each other.
